(19) United States
(12) Patent Application Publication
(10) Pub. No.: US 2020/0148975 A1
(43) Pub. Date: May 14, 2020

(54) ADVANCED NOVEL ECO-FRIENDLY COMPOSITIONS

(71) Applicant: Zvika Medlinski, Gan Yavne (IL)

(72) Inventor: Zvika Medlinski, Gan Yavne (IL)

(21) Appl. No.: 16/682,172

(22) Filed: Nov. 13, 2019

Related U.S. Application Data
(63) Continuation-in-part of application No. 15/751,956, filed on Feb. 12, 2018.
(60) Provisional application No. 62/204,518, filed on Aug. 13, 2015.

(51) Int. Cl. C11D 1/825; C11D 3/04; C11D 3/12; C11D 3/20; C11D 3/22

(52) U.S. Cl. CPC C11D 1/825; C11D 3/046; C11D 3/044; C11D 3/1213; C11D 3/1226; C11D 1/72; C11D 3/2079; C11D 3/222; C11D 3/2044; C11D 3/2065; C11D 3/048

(57) ABSTRACT

The present invention relates to Eco-friendly compositions for domestic and industrial applications as well as cleaning materials and detergents. In particular, the present invention relates to non-toxic “green” noval compositions including: about 1.0% to about 5.0% of Sodium Carbonate, about 0.1% to about 6.0% Potassium Hydroxide, up to 1.0% D-Limonene, and about to 1.5% to about 6.0% Alkyl Polyglycosides.

### CROSS-REFERENCE TO RELATED APPLICATIONS

This application is a continuation in part (CIP) of co-pending U.S. application Ser. No. 15/751,956 for “NOVEL ECO-FRIENDLY COMPOSITIONS”, filed on Feb. 12, 2018, claiming priority from provisional U.S. Patent Application Ser. No. 62/204,518 filed Aug. 13, 2015, the disclosures of which are incorporated by reference herein in its entirety.

### FIELD OF THE INVENTION

The present invention relates to eco-friendly compositions for domestic and industrial applications as well as cleaning materials and detergents. In particular, the present invention relates to non-toxic “green” novel compositions.

### BACKGROUND OF THE INVENTION

There has long existed the need for a system and methodology for providing “green” cleaning for a wide variety of industrial application, which include, by way of example only, cleaning publicly open and official facilities, offices, airports, hospitals and institutions, cleaning in the commercial and mostly large-scaled food- and nonfood-industry, cleaning hard surface, cleaning floors, carpets, machine ware washing, institutional laundry, commercial laundry, dairy cleaning, breweries cleaning, food plant cleaning, bottle cleaning, metal cleaning, automatic vehicle cleaning and chain lubrication.

The “most commonly used” detergents are based on: alkalis, acids, polluting chemicals containing metals, borates, phosphates, and the like, which can have adverse effects on the air, rivers, seas, water treatments, food chain and the environment in general.

Furthermore, the human and/or animal body is exposed to a wide variety of hazards, including but not limited to alkalis, acids, polluting chemicals containing metals, borates, phosphates wherein some of the inherent risks involved with the above identified materials are inherently “visible” while others are not.

In the human body, it has been seen that the lungs, eyes and skin are the most vulnerable to cleaning substances including alkalis, acids, polluting chemicals containing metals, borates and phosphates.

Various prior art apparatuses and methods have been described and reviewed in earlier publications, which are incorporated herein by reference for all purposes as if fully set forth herein.

Thus, such inventions as those described above generally suffer from at least one of several disadvantages, including, amongst others, creating bad smells, rot and/or fermentation next to refuse cans and sights, do not protect the environment, do not naturally breaks down in nature and/or are not readily biodegradable, do not offer minimal impact on earth, water sources and reservoirs, ground water and sea, do not protect sewerage pipes and drainage systems, sterilizes and cleans cesspits, affect the lungs, leave marks on skin or hands, toxic, flammable, ionic, discharge toxic gas or synthetics smell, contain, caustic soda or heavy metals, harm or degrade surfaces, including stainless steel, contain SLS, are foamy, leave greasy or sticky layers on surfaces, create slippery surfaces, stain or leave deposits, do not leave cleaned surfaces shiny and sparkling, cannot be applied to wet surfaces, cannot be diluted to suit application, are not economical in use, do not meet health bureaus standards, do not eliminate the need to use of soap and water post cleaning, require more than just “wiping”, do not reduce cut the cost of water and sewerage to the authorities, do not reduce the physical deterioration of workplace surfaces including metals, plastic, rubber and do not attack surfaces with stainless steel.

Thus, it would be extremely desirable to have a system and method capable of dissolving, detaching, and/or removing a variety of fats, dirt, grime and waste. Furthermore, it would be desirable to have an aqueous system and method capable of rapidly sterilizing, cleaning, removing and breaking down fatty chains, soil, dirt, burnt fats, grease, soot, charcoal coal and sludge, eliminating bacteria, microorganisms fungus and mold, with the cleaning leaving natural plant essences and/or performing “green” cleaning, being environmental and user friendly and meeting or exceeding European Standards such as the European EN1276 standard.

### SUMMARY OF THE INVENTION

The present invention is a plurality of non-toxic “green” compositions for domestic and/or industrial applications.

### DETAILED DESCRIPTION OF THE INVENTION

The non-toxic “green” compositions for domestic and/or industrial applications according to the present invention can be utilized in a wide range of applications, including but not limited to: treating crops for both pre-harvest and post-harvest treatments, antibacterial applications, antifungal applications, “non-toxic” cleaning, “green” cleaning, oil removal and/or breakdown, treatment by fogging and by way of foggers for containing and transporting material and produce, sanitization, disinfecting applications, “non-toxic” cleaning and treating of food materials and foodstuffs.

Preferably, the “green” compositions for agriculture according to the present invention are geared towards both prophylactic and remedial treatment of crops. Because of their high water content in particular, crops have a tendency towards large losses caused by various factors including but not limited to: Mechanical damage that includes torn, chopped, squashed or cut crop items, which are classified as mechanically damaged if the damage extends to more than 5 mm below the surface. Very loose-skinned crops also fall into this category, if over 25% of their skin is missing or loose, and animal damage is caused when crops are eaten by worms, snails and mice. On board an ocean-going vessel, there is a particular risk of the introduction of rats and mice. For this reason, increased attention should be paid to nibbled crops and to rat and mouse droppings, Freezing injury: the crop skin can be easily detached and the damaged tissue parts become watery and soft. After a relatively long period of chilling, the crop flesh can display a dark marbled effect when cut open, Damage due to chemicals: if crops come into contact with fertilizing salts or other corrosive chemicals, the skin and flesh can deteriorate by the corrosive action of these chemicals.

The best known rots, caused by temperatures >20° C., high humidity and inadequate air circulation, are: rot or late blight which includes but is not limited to: a fungal disease caused by the fungus Phytophthora infestans and may be recognized from the lead-gray, sunken spots of indeterminate shape which cover the crop surface and extend into the crop flesh as brown to red areas which are unclearly defined relative to the healthy tissue.

Late blight may spread very extensively in only a few days. It is often not clearly detectable at the time of sampling, due to the assumption of considerable dimensions during maritime transport. Additional bacteria frequently penetrate through the affected tissue, causing so-called wet rot, which has no common origin with late blight, Wet rot caused by bacteria (Pectobacterium carotovorum), which penetrates the flesh of damp or damaged potatoes, often through small cracks, and turns it mushy. Often, some of a crop suffering from wet rot is still firm, while the rest is brown and soft. The disease may spread through an entire cargo within just a few weeks. The bacteria either attach themselves to a damaged crop or have already attacked the crops previously during growth through black-leg stems.

Additional Potato disorders includes, but are not limited to: Black Scurf, Black Leg, Deep pitted scab, Common scab, Silver scurf, Verticillum wilt, Black dot, Powdery scab, early blight, late blight, leak, Fusarium dry rot, White mold, Charcoal rot, Root knot nematodes, Potato tuber moth, wire worms, internal necrosis, blackspot, hollow heart, gangrene, potato viruses and black heart.

Wet rot may have devastating consequences. The disease is suppressed by cool, dry stowage and regular ventilation. Crops suffering from wet rot crush easily in the hand: all that is required is finger pressure on the affected point, the mushy mess which is discharged being the characteristic feature of wet rot. Diseased crops are often squashed by the pressure of crops lying on top, allowing the bacteria to go on to infect healthy crop. This makes wet rot difficult to suppress, and it frequently leads to loss of the entire cargo; dry rot: discernible from sunken points and staining; white mold: discernible from a white, fluffy mealy deposit on the tuber surface; heart rot: determinable from the cavities inside the tuber; quarantinable diseases including but not limited to: potato wart: determinable from the cauliflower-like outgrowths; ring rot; fungal ring rot; bacterial ring rot: characterized by discoloration of the vascular ring; and powdery scab: rough corky unevenness's on the skin surface and potato moth.

The following conclusions can be drawn from the appearance of the potatoes during the unloading process or from changes in the atmospheric environment: soft, black potatoes are caused by inadequate ventilation, chilling is recognized by black coloration beneath the potato skin, a rapid increase in temperature is caused by the more intense respiration of diseased tubers and indicates the presence of seats of rot which must be removed immediately, if the temperature of the cargo increases excessively, only forced ventilation can save the cargo from overheating and thus rapid decay and greening of the tubers indicates that the tubers have been exposed to strong sunlight or artificial light during storage ashore or on board (particularly on ro-ro ships).

Damaging pests can work quickly in a potato patch. Early diagnosis and identification are known in the art as an attempt to limit the damage caused by way of strolling through the plot regularly looking for insects and indicative damage caused. It is well known in the art that it's a lot easier to deal with a pest before it becomes a disaster. Invariably, usage of sprays or dusts to prevent or control a pest problem, required reading the directions and following them carefully albeit the inherent risk in using toxic material on edible plants.

The Colorado Potato beetle is present and destroys any potato bugs you see and check the underside of leaves for their orange egg masses. Both the adults, which are yellowish with black stripes, and the larvae, which are dark red or orange with black spots, feed on potato foliage. Pick them off or spray Bacillus thuringiensis San Diego on the young larvae. Bacillus thuringiensis ‘San Diego’ attacks only the potato beetle larvae and is harmless to beneficial insects, animals and humans.

Flea beetles are tiny, black or brown, and pesky and are known to be able to chew small holes in plant leaves rapidly causing serious damage, especially when Flea beetles attack young plants. Attempts of circumventing such damage known in the art include covering young plants with fabric row covers as soon as you set young plants out as well as attempting to keep flea beetle populations low through crop rotation and by maintaining high soil organic matter.

Aphid include tiny insects can transmit virus diseases. Aphid “suck” juices and/or sap from the leaves and stems of potato plants, injuring them badly. Insecticidal soap sprays are an effective control known in the art nevertheless toxicity of such insecticidal sprays has remained a concern in such use.

Wireworms are the larvae of the click beetle. Wireworms are a problem when potatoes are planted in a section of garden that was recently sodded. Fully grown wireworms are ½- to 1½-inches long, they are slender, brownish or yellowish white and tunnel into plant roots and tubers, spoiling them. Attempts known in the to address the wireworks damage have included growing potatoes in a “tower” fashion.

The fungus that causes common scab lives in the soil for many years. Nevertheless, the fungus is not active, though, when the soil pH is below 5.4, so if you have a serious scab problem, take a soil pH test. You may want to lower the pH by not liming or adding wood ashes to the potato section of the garden.

Early blight injures foliage and reduces overall yields. Affected leaves develop small, dark brown spots that often grow in size, and which eventually kill the leaves. Gardens in central, southern and eastern states are most susceptible. Planting certified seed and mulching with hay can prevent this disease.

Late blight is caused by the downy mildew fungus—Phytophthora infestans, which triggered the Irish crop failures of 1845 and 1846. You'll notice the disease first by water-soaked areas on the leaves that turn brown and black as the leaf dies. The disease strikes often during cool, wet weather and may spread rapidly if the weather warms up. Plants can die in a severe case, and potatoes can be seriously affected, especially in storage. Plant certified seed and use a potato dust to guard against late blight.

Mosaic virus are commonly spread by Aphids, which cause potato leaves to curl and appear almost two-toned (light and dark green). Mosaic virus occurs throughout the United States and cuts down on the harvest, but Mosaic does not kill the plants. ‘Kennebec’ and ‘Katahdin’ varieties have some resistance to certain kinds of mosaic virus.

The term “caustic” as used herein, shall include but will not be limited to: capable of burning, corroding, dissolving, or eating away by chemical action and A hydroxide of a light metal.

The term “anionic” detergent as used herein, shall include but will not be limited to: a class of synthetic detergents in which the molecules do not ionize in aqueous solutions.

The term “Sodium Carbonate” as used herein, shall include but will not be limited to: a crystalline heptahydrate, which readily effloresces to form a white powder, the monohydrate. Pure sodium carbonate is a white, odorless powder that is hygroscopic (absorbs moisture from the air), has an alkaline taste, and forms a strongly alkaline water solution. Sodium carbonate is well known domestically for its everyday use as a water softener. Sodium carbonate can be extracted from the ashes of many plants growing in sodium-rich soils, such as vegetation from the Middle East, kelp from Scotland and seaweed from Spain. Because the ashes of these sodium-rich plants were noticeably different from ashes of timber (used to create potash), they became known as “soda ash”.

Sodium carbonate is synthetically produced in large quantities from salt (sodium chloride) and limestone by a method known as the Solvay process. In chemistry, sodium carbonate is often used as an electrolyte. Electrolytes are usually salt-based, and sodium carbonate acts as a very good conductor in the process of electrolysis. In addition, unlike chloride ions, which form chlorine gas, carbonate ions are not corrosive to the anodes. Sodium carbonate is also used as a primary standard for acid-base titrations because sodium carbonate is solid and air-stable, making it easy to weigh accurately. Sodium carbonate is also used as a relatively strong base in various settings. For example, sodium carbonate is used as a pH regulator to maintain stable alkaline conditions necessary for the action of the majority of photographic film developing agents.

Sodium carbonate is a common additive in municipal pools used to neutralize the corrosive effects of chlorine and raise the pH. It is used as a water softener in laundering: it competes with the magnesium and calcium ions in hard water and prevents them from bonding with the detergent being used. Sodium carbonate can be used to remove grease, oil and wine stains. Sodium carbonate is also used as a descaling agent in boilers such as those found in coffee pots and espresso machines. Sodium carbonate is a food additive (E500) used as an acidity regulator, anti-caking agent, raising agent, and stabilizer. It is also used in the production of snus (Swedish-style snuff) to stabilize the pH of the final product. In Sweden, snus is regulated as a food product because it is put into the mouth, requires pasteurization, and contains only ingredients that are approved as food additives. Sodium carbonate, in a solution with common salt, may be used for cleaning silver. In a non-reactive container (glass, plastic or ceramic) aluminum foil and the silver object are immersed in the hot salt solution. The elevated pH dissolves the aluminum oxide layer on the foil and enables an electrolytic cell to be established. Hydrogen ions produced by this reaction reduce the sulfide ions on the silver restoring silver metal. The sulfide can be released as small amounts of hydrogen sulfide. Rinsing and gently polishing the silver restores a highly polished condition.

The term “Potassium Hydroxide” as used herein, shall include but will not be limited to: a colorless solid is a prototypical strong base. It has many industrial and niche applications; most applications exploit its reactivity toward acids and its corrosive nature. KOH is noteworthy as the precursor to most soft and liquid soaps as well as numerous potassium-containing chemicals. Potassium hydroxide is usually sold as translucent pellets, which will become tacky in air because KOH is hygroscopic. Consequently, KOH typically contains varying amounts of water (as well as carbonates, see below). Its dissolution in water is strongly exothermic, meaning the process gives off significant heat. Concentrated aqueous solutions are sometimes called potassium lyes. Even at high temperatures, solid KOH does not dehydrate readily. Potassium hydroxide solutions with concentrations of approximately 0.5 to 2.0% are irritating when coming in contact with the skin, while concentrations higher than 2% are corrosive. KOH, like NaOH, serves as a source of OH—, a highly nucleophilic anion that attacks polar bonds in both inorganic and organic materials. In perhaps the most well-known reaction of KOH, aqueous KOH saponifies esters: which are manifested by the “greasy” feel that KOH gives when touched—fats on the skin are rapidly converted to soap and glycerol. Potassium hydroxide is also used in petroleum and natural gas refining for removal of organic acids and sulfur compounds. The saponification of fats with KOH is used to prepare the corresponding “potassium soaps,” which are softer than the more common sodium hydroxide-derived soaps. Because of their softness and greater solubility, potassium soaps require less water to liquefy, and can thus contain more cleaning agent than liquefied sodium soaps.

The term “STPP” as used herein, shall include but will not be limited to: a sodium salt of the polyphosphate penta-anion, which is the conjugate base of triphosphoric acid. It is produced on a large scale as a component of many domestic and industrial products, especially detergents. Environmental problems associated with eutrophication are attributed to its widespread use.

Sodium tripolyphosphate is produced by heating a stoichiometric mixture of disodium phosphate, Na₂HPO₄, and monosodium phosphate, NaH₂PO₄, under carefully controlled conditions known in the art. STPP is a colorless salt, which exists both in anhydrous form and as the hexahydrate. The anion can be described as the pentanionic chain [O₃POP(O)₂OPO₃]^{5-.} Many related di-, tri-, and polyphosphates are known including the cyclic triphosphate P₃O₉³⁻. It binds strongly to metal cations as both a bidentate and tridentate chelating agent. The majority of STPP is consumed as a component of commercial detergents. It serves as a “builder,” industrial jargon for a water softener. In hard water (water that contains high concentrations of Mg²⁺ and Ca²⁺), detergents are deactivated. Being a highly charged chelating agent, TPP⁵⁻ binds to dications tightly and prevents them from interfering with the sulfonate detergent.

The term “Sodium Bisulfate” as used herein, shall include but will not be limited to: sodium hydrogen sulfate, a sodium salt of the bisulfate anion, with the molecular formula NaHSO₄. Sodium bisulfate is an acid salt formed by partial neutralization of sulfuric acid by an equivalent of sodium base, typically either in the form of sodium hydroxide or sodium chloride. It is a dry granular product that can be safely shipped and stored. The anhydrous form is hygroscopic. Solutions of sodium bisulfate are acidic, with a 1M solution having a pH of <1. Not to be confused with Sodium Bisulfite. Sodium bisulfate is used primarily to lower pH. For technical-grade applications, it is used in metal finishing, cleaning products, and to lower the pH of water for effective chlorination, including swimming pools. Sodium bisulfate is also AAFCO approved as a general-use feed additive, including companion animal food. It is highly toxic to at least some echinoderms, but fairly harmless to most other life forms; sodium bisulfate is used in controlling outbreaks of crown-of-thorns starfish. In jewelry making, sodium bisulfate is the primary ingredient used in many pickling solutions to remove the oxidation layer from surfaces, which occurs after heating. Sodium bisulfate was the primary active ingredient in crystal toilet bowl cleaners Vanish and Sani-Flush, both now discontinued. Sodium bisulfate is used as a food additive. Sodium bisulfate is considered GRAS (Generally Recognized As Safe) by the FDA. Further, Sodium Bisulfate is considered a “natural product” by the FDA, IANPP (International Association of Natural Products Producers) and the NIRC (Natural Ingredients Resource Center). The food-grade product also meets the requirements set out in the Food Chemicals Codex. It is denoted by E number E514ii in the EU and is also approved for use in Australia, New Zealand, Canada and Mexico where it is listed as additive 514. Food-grade sodium bisulfate is used in a variety of food products, including beverages, dressings, sauces, and fillings. It has many synonyms (Bisulfate of soda, Sodium bisulfate, Sodium acid sulfate, Mono sodium hydrogen sulfate, Monosodium salt, Sodium hydrogen sulfate, Sodium hydrosulfate, Sodium pyrosulfate, Sulfuric acid, Sulfuric acid sodium salt (1:1).

The term “DPM” as used herein, shall include but will not be limited to: a Dipropylene glycol monomethyl ether is commonly used for Surface tension reduction and slow evaporation are some of the benefits of using Glycol Ether DPM in cleaning formulations. DPM has a low odor and slow evaporation rate. It is a good choice for wax strippers and floor cleaners which are spread over a large area. When used in an enclosed area, a floor cleaner containing a fast-evaporating solvent might produce an undesirable amount of solvent vapor. Glycol Ether DPM provides good solvency for polar and non-polar materials. Other Applications: The properties listed in the previous section also support the use of Glycol Ether DPM in agricultural, cosmetic, electronic, ink, textile and adhesive products. Oxidizes readily in air to form unstable peroxides that may explode spontaneously [Bretherick, 1979 p. 151-154, 164]. Miscible with water. Dipropylene glycol monomethyl ether may react violently with strong oxidizing agents. May generate flammable and/or toxic gases with alkali metals, nitrides, and other strong reducing agents. May initiate the polymerization of isocyanates and epoxides.

The term “APG (DOW)” as used herein, shall include but will not be limited to: an Alkyl polyglycosides manufactured by the DOW™ corporation including the TRITON™ BG and BC formulations.

Meta Silicate—A salt of metasilicic acid H₂SiO₃ selected from the group consisting of:

Sodium metasilicate

Calcium metasilicate

Barium metasilicate

The term “Alkyl polyglycosides (APGs)” as used herein, shall include but will not be limited to: a class of non-ionic surfactants widely used in a variety of household and industrial applications. APGs are derived from sugars, usually glucose derivatives, and fatty alcohols. The raw materials for industrial manufacture are typically starch and fat, and the final products are typically complex mixtures of compounds with different sugars comprising the hydrophilic end and alkyl groups of variable length comprising the hydrophobic end. When derived from glucose, APGs are known as alkyl polyglucosides. APGs are used to enhance the formation of foams in detergents for dishwashing and for delicate fabrics. In addition to their favorable foaming properties, APGs are attractive because they readily biodegrade. Alkyl glycosides are produced by combining anhydrous glucose or its monohydrate, in the presence of acid catalysts at elevated temperatures. Water released in the reaction mixture is removed from the reaction chamber in the gaseous phase. A partial flow is withdrawn from the liquid reaction mixture and conveyed to a preliminary mixing zone, into which the powdered reactant is introduced simultaneously, where it is processed with the liquid partial flow to a paste and conveyed through a downstream intensive mixer to the reaction chamber. This pressure in the preliminary mixing zone is equalized directly and simultaneously with the reduced pressure in the reaction chamber by the intensive mixer and with atmospheric pressure by the conveying device for the powdered glycose. The consistency of the paste formed in the preliminary mixing zone is chosen so that this paste can be used as a sealant for pressure equalization and hence as a so-called “living seal”.

The term “Carboxylic acid” as used herein, shall include but will not be limited to: an compound selected from the group of compound including an organic compound that contains a carboxyl group (C(O)OH). The general formula of a carboxylic acid is R—C(O)OH with R referring to the rest of the (possibly quite large) molecule. Carboxylic acids occur widely and include the amino acids and acetic acid (active ingredient in vinegar), Salts and esters of carboxylic acids are called carboxylates. When a carboxyl group is deprotonated, its conjugate base forms a carboxylate anion. Carboxylate ions are resonance-stabilized, and this increased stability makes carboxylic acids more acidic than alcohols. Carboxylic acids can be seen as reduced or alkylated forms of the Lewis acid carbon dioxide; under some circumstances Carboxylic acids can be decarboxylated to yield carbon dioxide.

The term “Polysorbate 20” as used herein, shall include but will not be limited to: (common commercial brand names include Scattics, Alkest TW 20 and Tween 20) is a polysorbate surfactant whose stability and relative non-toxicity allows it to be used as a detergent and emulsifier in a number of domestic, scientific, and pharmacological applications. It is a polyoxyethylene derivative of sorbitan monolaurate and is distinguished from the other members in the polysorbate range by the length of the polyoxyethylene chain and the fatty acid ester moiety. The commercial product contains a range of chemical species. Polysorbate 20 is used as a wetting agent in flavored mouth drops such as Ice Drops, helping to provide a spreading feeling to other ingredients like SD alcohol and mint flavor. The World Health Organization has suggested acceptable daily intake limits of 0-25 mg of polyoxyethylene sorbitan esters per kg body weight

In biological techniques and sciences, Polysorbate 20 has a broad range of applications. For example, it is used:
as a washing agent in immunoassays, such as Western blots and ELISAs. It helps to prevent non-specific antibody binding. In this major application, it is dissolved in Tris-Buffered Saline or Phosphate buffered saline at dilutions of 0.05% to 0.5% v/v. These buffers are used for washes between each immune-reactions, to remove unbound immunologicals, and eventually for incubation solutions of immunoreagents (labeled antibodies) to reduce unspecific background.
as a solubilizing agent of membrane proteins
for lysing mammalian cells, at a concentration of 0.05% to 0.5% v/v, generally combined with other detergents, salts and additives
The Clorox-made cleaning solution used by the iRobot Scooba floor-washing robot lists Tween 20 as one of its major ingredients on its MSDS.
Polysorbate 20 is also used by philatelists to remove stamps from envelopes and to remove residues from stamps, without harming the stamp itself.
   Polysorbate 20 is also used as wetting agent in rubber baler in the elastomer industry
   Recently Polysorbate 20 (Tween 20) has been used as a shape directing agent to synthesize spheroidal magnetite nano-assemblies

The term “PEG” as used herein, shall include but will not be limited to: an oligomer or polymer of ethylene oxide. Historically, PEG has tended to refer to oligomers and polymers with a molecular mass below 20,000 g/mol, PEO to polymers with a molecular mass above 20,000 g/mol, and POE to a polymer of any molecular mass. PEG and PEO are liquids or low-melting solids, depending on their molecular weights. PEGs are prepared by polymerization of ethylene oxide and are commercially available over a wide range of molecular weights from 300 g/mol to 10,000,000 g/mol. While PEG and PEO with different molecular weights find use in different applications and have different physical properties (e.g. viscosity) due to chain length effects, their chemical properties are nearly identical. Different forms of PEG are also available, depending on the initiator used for the polymerization process—the most common initiator is a monofunctional methyl ether PEG, or methoxypoly (ethylene glycol), abbreviated mPEG. Lower-molecular-weight PEGs are also available as purer oligomers, referred to as monodisperse, uniform, or discrete. Very high purity PEG has recently been shown to be crystalline, allowing determination of a crystal structure by x-ray diffraction. Since purification and separation of pure oligomers is difficult, the price for this type of quality is often ten-fold to 1000-fold that of polydisperse PEG.

PEGs are also available with different geometries.
Branched PEGs have three to ten PEG chains emanating from a central core group.
Star PEGs have 10 to 100 PEG chains emanating from a central core group.
Comb PEGs have multiple PEG chains normally grafted onto a polymer backbone

The term “Potassium sorbate” as used herein, shall include but will not be limited to: a potassium salt of sorbic acid, chemical formula CH₃CH═CH—CH═CH—CO₂K. It is a white salt that is very soluble in water (58.2% at 20° C.). It is primarily used as a food preservative (E number 202). Potassium sorbate is effective in a variety of applications including food, wine, and personal care products. While sorbic acid is naturally occurring in some berries, virtually all of the world's production of sorbic acid, from which potassium sorbate is derived, is manufactured synthetically. Potassium sorbate is produced industrially by neutralizing sorbic acid with potassium hydroxide. The precursor sorbic acid is produced in a two-step process via the condensation of crotonaldehyde and ketene. Potassium sorbate is used to inhibit molds and yeasts in many foods, such as cheese, wine, yogurt, dried meats, apple cider, soft drinks and fruit drinks, and baked goods. It is used in the preparation of items such as Sweet maple syrup and milkshakes served by fast food conglomerates such as McDonalds. It can also be found in the ingredients list of many dried fruit products. In addition, herbal dietary supplement products generally contain potassium sorbate, which acts to prevent mold and microbes and to increase shelf life. It is used in quantities at which there are no known adverse health effects, over short periods of time. Labeling of this preservative on ingredient statements reads as “potassium sorbate” or “E202”. Also, it is used in many personal care products to inhibit the development of microorganisms for shelf stability. Some manufacturers are using this preservative as a replacement for parabens. Tube feeding of potassium sorbate reduces gastric burden of pathogenic bacteria. Also known as “wine stabilizer”, potassium sorbate produces sorbic acid when added to wine. It serves two purposes. When active fermentation has ceased and the wine is racked for the final time after clearing, potassium sorbate will render any surviving yeast incapable of multiplying. Yeast living at that moment can continue fermenting any residual sugar into CO2 and alcohol, but when yeast die, no new yeast will be present to cause future fermentation. When a wine is sweetened before bottling, potassium sorbate is used to prevent refermentation when used in conjunction with potassium metabisulfite. It is primarily used with sweet wines, sparkling wines, and some hard ciders but may be added to table wines which exhibit difficulty in maintaining clarity after fining. Some molds (notably Trichoderma and Penicillium strains) and yeasts are able to detoxify sorbates by decarboxylation, producing piperylene (1,3-pentadiene). The pentadiene manifests as a typical odor of kerosene or petroleum. Pure potassium sorbate is a skin, eye and respiratory irritant. Typical culinary usage rates of potassium sorbate are 0.025% to 0.1% (see sorbic acid), which in a 100 g serving yields an intake of 25 mg to 100 mg. The maximum acceptable daily intake for human consumption is 25 mg/kg, or 1750 mg daily for an average adult (70 kg). Under some conditions, particularly at high concentrations or when combined with nitrites, potassium sorbate has shown genotoxic activity in vitro; however, potassium sorbate is regarded as safer than sodium sorbate. Although some research implies potassium sorbate has a long-term safety record, in vitro studies have shown that potassium sorbate is both genotoxic and mutagenic to human blood cells. Potassium sorbate is found to be toxic to human DNA in peripheral blood lymphocytes, and hence found that potassium sorbate negatively affects immunity. Potassium sorbate is often used with ascorbic acid and iron salts as they increase effectiveness but tend to form mutagenic compounds that damage DNA molecules. Regardless, it has not been found to have any carcinogenic effects in rats.

The term “Quaternary ammonium cations” as used herein, shall include but will not be limited to: a quat, a positively charged polyatomic ion of the structure NR₄⁺, R being an alkyl group or an aryl group. Unlike the ammonium ion (NH₄⁺) and the primary, secondary, or tertiary ammonium cations, the quaternary ammonium cations are permanently charged, independent of the pH of their solution. Quaternary ammonium salts or quaternary ammonium compounds (called quaternary amines in oilfield parlance) are salts of quaternary ammonium cations.

### As Antimicrobials

Quaternary ammonium compounds have also been shown to have antimicrobial activity. Certain quaternary ammonium compounds, especially those containing long alkyl chains, are used as antimicrobials and disinfectants. Examples are benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide. Also good against fungi, amoebas, and enveloped viruses, Quaternary ammonium compounds are believed to act by disrupting the cell membrane. Quaternary ammonium compounds are lethal to a wide variety of organisms except endospores, Mycobacterium tuberculosis and non-enveloped viruses. Quaternary ammonium compounds are cationic detergents, as well as disinfectants, and as such can be used to remove organic material. Quaternary ammonium compounds are very effective in combination with phenols. Quaternary ammonium compounds are deactivated by anionic detergents (including common soaps). Also, Quaternary ammonium compounds work best in soft waters. Effective levels are at 200 ppm. Quaternary ammonium compounds are effective at temperatures up to 212° F. (100° C.). Quaternary ammonium salts are commonly used in the foodservice industry as sanitizing agents.

The term “Polysaccharide (Xantan)” as used herein, shall include but will not be limited to: a polysaccharide secreted by the bacterium Xanthomonas campestris, used as a food additive and rheology modifier, commonly used as a food thickening agent (in salad dressings, for example) and a stabilizer (in cosmetic products, for example, to prevent ingredients from separating). It is composed of pentasaccharide repeat units, comprising glucose, mannose, and glucuronic acid in the molar ratio 2.0:2.0:1.0. It is produced by the fermentation of glucose, sucrose, or lactose. After a fermentation period, the polysaccharide is precipitated from a growth medium with isopropyl alcohol, dried, and ground into a fine powder. Later, it is added to a liquid medium to form the gum. One of the most remarkable properties of xanthan gum is its ability to produce a large increase in the viscosity of a liquid by adding a very small quantity of gum, on the order of one percent. In most foods, it is used at 0.5%, and can be used in lower concentrations. The viscosity of xanthan gum solutions decreases with higher shear rates; this is called shear thinning or pseudo-plasticity. This means that a product subjected to shear, whether from mixing, shaking or even chewing, will thin out, but, once the shear forces are removed, the food will thicken back up. A practical use would be in salad dressing: The xanthan gum makes it thick enough at rest in the bottle to keep the mixture fairly homogeneous, but the shear forces generated by shaking and pouring thins it, so it can be easily poured. When it exits the bottle, the shear forces are removed and it thickens back up, so it clings to the salad. Unlike other gums, it is very stable under a wide range of temperatures and pH. In foods, xanthan gum is most often found in salad dressings and sauces. It helps to prevent oil separation by stabilizing the emulsion, although it is not an emulsifier. Xanthan gum also helps suspend solid particles, such as spices. Also used in frozen foods and beverages, xanthan gum helps create the pleasant texture in many ice creams, along with guar gum and locust bean gum. Toothpaste often contains xanthan gum, wherein it serves as a binder to keep the product uniform. Xanthan gum also helps thicken commercial egg substitutes made from egg whites, to replace the fat and emulsifiers found in yolks. It is also a preferred method of thickening liquids for those with swallowing disorders, since it does not change the color or flavor of foods or beverages at typical use levels. Xanthan gum is also used in gluten-free baking. Since the gluten found in wheat must be omitted, xanthan gum is used to give the dough or batter a “stickiness” that would otherwise be achieved with the gluten. In the oil industry, xanthan gum is used in large quantities, usually to thicken drilling mud. These fluids serve to carry the solids cut by the drilling bit back to the surface. Xanthan gum provides great “low end” rheology. When the circulation stops, the solids still remain suspended in the drilling fluid. The widespread use of horizontal drilling and the demand for good control of drilled solids has led to its expanded use. It has also been added to concrete poured underwater, to increase its viscosity and prevent washout. In cosmetics, xanthan gum is used to prepare water gels, usually in conjunction with bentonite clays. It is also used in oil-in-water emulsions to help stabilize the oil droplets against coalescence. It has some skin hydrating properties. Xanthan gum is a common ingredient in fake blood recipes, and in gunge/slime. The greater the weight ratio of xanthan gum added to a liquid, the thicker the liquid will become. In general, 0.2% by weight of xanthan gum results in slight thickening. A thicker sauce is obtained with 0.7-1.5% xanthan gum. Too much xanthan gum can result in an unpleasant and undesirable slimy texture. An emulsion can be formed with as little as 0.1% xanthan gum. Increasing the amount of gum gives a thicker, more stable emulsion. A thick, stable emulsion is obtained with about 0.8% xanthan gum. To make a foam, 0.2-0.8% xanthan gum is typically used. Larger amounts result in larger bubbles and denser foam. Egg white powder (0.2-2.0%) with 0.1-0.4% xanthan gum yields bubbles similar to soap bubbles. Evaluation of workers exposed to xanthan gum dust found evidence of a link to respiratory symptoms. On May 20, 2011 the FDA issued a press release about Simply Thick, a food-thickening additive containing xanthan gum as the active ingredient, warning “parents, caregivers and health care providers not to feed Simply Thick, a thickening product, to premature infants.” The concern is that the product may cause necrotizing enterocolitis (NEC). Xanthan gum may be derived from a variety of source products that are themselves common allergens, such as corn, wheat, dairy, or soy. As such, persons with known sensitivities or allergies to food products are advised to avoid foods including generic xanthan gum or first determine the source for the xanthan gum before consuming the food. To be specific, an allergic response may be triggered in people exceedingly sensitive to the growth medium, usually corn, soy, or wheat. For example, residual wheat gluten has been detected on xanthan gum made using wheat. This may trigger a response in people exceedingly sensitive to gluten. Although, the vast majority of industrially manufactured xanthan gum contains far less than 20 ppm gluten, which is the EU limit for “gluten free” labelling. Xanthan gum is a “highly efficient laxative,” according to a study that fed 15 g/day for 10 days to 18 normal volunteers. This is not a dosage that would be encountered in normal consumption of foodstuffs. This study set out to examine the use of xanthan gum as a laxative. As described above, xanthan gum binds water very efficiently, which significantly aids passing stools.^{[13]} Some people react to much smaller amounts of xanthan gum with symptoms of intestinal bloating and diarrhea. There are many substitutes for xanthan gum when used for baking such as guar gum and locust bean gum.

The term “Sodium Biborate” as used herein, shall include but will not be limited to: a white crystalline compound that consists of a hydrated sodium borate Na₂B₄O₇. 10H₂O, that occurs as a mineral or is prepared from other minerals, and that is used especially as a flux, cleansing agent, and water softener, as a preservative, and as a fireproofing agent. Common borate salts include sodium metaborate, NaBO2, and sodium tetraborate, Na2B4O7, which is usually encountered as borax the so-called decahydrate, and actually contains the hydroxoborate ion, B4O5(OH)4 2- and is formulated Na2[B4O5(OH)4]. 8H2O.

The term “Sodium benzoate” as used herein, shall include but will not be limited to: has the chemical formula NaC₇H₅O₂; it is a widely used food preservative, with E number E211. It is the sodium salt of benzoic acid and exists in this form when dissolved in water. It can be produced by reacting sodium hydroxide with benzoic acid. Benzoic acid occurs naturally at low levels in cranberries, prunes, greengage plums, cinnamon, ripe cloves, and apples. Sodium benzoate is a preservative. As a food additive, sodium benzoate has the E number E211. It is bacteriostatic and fungistatic under acidic conditions. It is most widely used in acidic foods such as salad dressings (vinegar), carbonated drinks (carbonic acid), jams and fruit juices (citric acid), pickles (vinegar), and condiments. It is also used as a preservative in medicines and cosmetics. Concentration as a preservative is limited by the FDA in the U.S. to 0.1% by weight. Sodium benzoate is also allowed as an animal food additive at up to 0.1%, according to AFCO's official publication. The mechanism starts with the absorption of benzoic acid into the cell. If the intracellular pH falls to 5 or lower, the anaerobic fermentation of glucose through phosphofructokinase decreases sharply which inhibits the growth and survival of microorganisms that cause food spoilage. In the United States, sodium benzoate is designated as generally recognized as safe (GRAS) by the Food and Drug Administration. The International Program on Chemical Safety found no adverse effects in humans at doses of 647-825 mg/kg of body weight per day. Cats have a significantly lower tolerance against benzoic acid and its salts than rats and mice.

TABLE 1

| | Compound | Compound | Compound | Compound |
|---|---|---|---|---|
| | I % w/w | II % w/w | III % w/w | IV % w/w |
| Sodium | 0.5-2.5 | 2.0-3.0 | 2.0-3.0 | 0.5-2.5 |
| Carbonate | | | | |
| Potassium | 0.1-6 | 2.5-3.5 | 2.5-3.5 | 0.1-6 |
| Hydroxide | | | | |
| Vinegar 10% | 2.0-4.0 | 2.8-3.2 | 2.5-3.5 | 2.0-4.0 |
| STPP | 0.8-2.2 | 1.5-1.6 | 0-1.6 | 0.8-2.2 |
| Sodium Bisulfate | 0.4-1.0 | 0.4-0.6 | 0.4-0.6 | 0.4-1.0 |
| DPM | 10.0-12.0 | 8.0-15.0 | 10.0-12.0 | 10.0-12.0 |
| APG (DOW) | 0.5-3.5 | 2.3-2.7 | 0.5-3.2 | 0.5-3.5 |
| Alkyl | 1.5-6.0 | 2.5-3.5 | 2.5-3.5 | 1.5-6.0 |
| Polyglycosides | | | | |
| Polysorbate 20 | 0.01-0.6 | 0.01-0.6 | 0-0.6 | 0 |
| MMB | 0 | 2.5-3.5 | 2.5-5.0 | 2.5-3.5 |
| Carboxylic acid | 2.5-3.0 | 2.5-5.0 | 3.0 | 3.0 |
| Salidin 20 | 0 | 1.3-1.7 | 2.5-3.0 | 1.3-1.7 |
| HiTec151 ™ | 0.5-0.7 | 0 | 0.5-0.7 | 0.5-0.7 |
| Potassium | 0.01-0.4 | 0.01-0.4 | 0-0.4 | 0.01-0.4 |
| Sorbate | | | | |
| Polysaccharide | 0.01-0.1 | 0-0.1 | 0-0.1 | 0.01-0.1 |
| (Xantan) | | | | |
| Sodium Biborate | 0.01-0.1 | 0.01-0.1 | 0-0.1 | 0.01-0.1 |
| Potassium 2- | 0.2-1.0 | 0.2-1.0 | 0-1.0 | 0.2-1.0 |
| ethylhexanoate | | | | |
| ABC | 0.3-3.5 | 0.3-3.5 | 0-3.5 | 0 |
| Sodium Benzoate | 0-0.4 | 0.01-0.4 | 0 | 0 |
| Mono Propylene | 1.7-12.0 | 5.0-8.0 | 9.0-12.0 | 1.7-12.0 |
| Glycol | | | | |
| Nitrate | 0.1-0.3 | 0-0.2 | 0-0.2 | 0.1-0.3 |
| P₂O₅ | 0-0.2 | 0.1-0.3 | 0.1-0.3 | 0-0.2 |
| K₂O | 0.1-0.3 | 0-0.2 | 0.1-0.3 | 0-0.2 |
| Potash | 1.5-3.0 | 1.8-2.2 | 1.7-2.5 | 2.0 |
| Metallic Chelates | 0.001-0.002 | 0-0.01 | 0.001-0.005 | 0.002-0.004 |
| Meta Silicate | 0.2-2.5 | 0.8-1.8 | 0.8-1.8 | 0.2-2.5 |
| Purified ionized | To 100% | To 100% | To 100% | To 100% |
| water | | | | |

TABLE 2

| | Compound | Compound | Compound | Compound |
|---|---|---|---|---|
| | IV % w/w | V % w/w | VI % w/w | VII % w/w |
| Sodium | 2.0-3.0 | 2.0-3.0 | 0.5-2.5 | 2.0-3.0 |
| Carbonate | | | | |
| Potassium | 2.5-3.5 | 2.5-3.5 | 0.1-6 | 2.5-3.5 |
| Hydroxide | | | | |
| Vinegar 10% | 2.0-4.0 | 2.8-3.2 | 2.5-3.5 | 2.0-4.0 |
| STPP | 1.5-1.6 | 0 | 0.8-2.2 | 1.5-1.6 |
| Sodium Bisulfate | 0.4-0.6 | 0 | 0.4-0.6 | 0.4-0.6 |
| DPM | 8.0-15.0 | 10.0-12.0 | 10.0-12.0 | 8.0-15.0 |
| APG (DOW) | 2.3-2.7 | 2.3-2.7 | 0.5-3.5 | 2.3-2.7 |
| Alkyl | 2.5-3.5 | 2.5-3.5 | 1.5-6.0 | 2.5-3.5 |
| Polyglycosides | | | | |
| Polysorbate 20 | 0-0.6 | 0-0.6 | 0.01-0.6 | 0.01-0.6 |
| Potassium | 0 | 0 | 0.01-0.4 | 0-0.4 |
| Sorbate | | | | |
| Quaternary | 0.005-0.007 | 0 | 0.005-0.007 | 0-0.007 |
| ammonium | | | | |
| cations | | | | |
| Polysaccharide | 0-0.1 | 0-0.1 | 0.01-0.1 | 0-0.1 |
| (Xantan) | | | | |
| MMB | 0 | 2.5-3.5 | 2.5-5.0 | 2.5-3.5 |
| Carboxylic acid | 2.5-3.0 | 2.5-5.0 | 3.0 | 3.0 |
| Salidin 20 | 0 | 1.3-1.7 | 2.5-3.0 | 1.3-1.7 |
| HiTec151 ™ | 0.5-0.7 | 0 | 0.5-0.7 | 0.5-0.7 |
| Sodium Biborate | 0-0.1 | 0 | 0.01-0.1 | 0-0.1 |
| Potassium 2- | 0.2-1.0 | 0-1.0 | 0.2-1.0 | 0-1.0 |
| ethylhexanoate | | | | |
| ABC | 0.3-3.5 | 0-3.5 | 0.3-3.5 | 0-3.5 |
| Sodium Benzoate | 0.01-0.4 | 0 | 0.01-0.4 | 0.01-0.4 |
| Mono Propylene | 3.0-5.0 | 0 | 1.7-12.0 | 2.0-5.0 |
| Glycol | | | | |
| Nitrate | 0.1-0.3 | 0-0.2 | 0-0.2 | 0.1-0.3 |
| P₂O₅ | 0-0.2 | 0.1-0.3 | 0.1-0.3 | 0-0.2 |
| K₂O | 0.1-0.3 | 0-0.2 | 0.1-0.3 | 0-0.2 |
| Potash | 1.5-3.0 | 1.8-2.2 | 1.7-2.5 | 2.0 |
| Metallic Chelates | 0.001-0.002 | 0-0.01 | 0.001-0.005 | 0.002-0.004 |
| Meta Silicate | 0.8-1.8 | 0 | 0.2-2.5 | 0.8-1.8 |
| Purified ionized | To 100% | To 100% | To 100% | To 100% |
| water | | | | |

TABLE 3

| | Compound | Compound | Compound | Compound |
|---|---|---|---|---|
| | IV % w/w | V % w/w | VI % w/w | VII % w/w |
| Sodium | 2.0-3.0 | 2.0-3.0 | 0.5-2.5 | 2.0-3.0 |
| Carbonate | | | | |
| Potassium | 2.5-3.5 | 2.5-3.5 | 0.1-6 | 2.5-3.5 |
| Hydroxide | | | | |
| HiTec151 ™ | 0.5-0.7 | 0 | 0.5-0.7 | 0.5-0.7 |
| Salidin 20 | 0 | 1.3-1.7 | 2.5-3.0 | 1.3-1.7 |
| Carboxylic acid | 2.5-3.0 | 2.5-5.0 | 3.0 | 3.0 |
| Vinegar 10% | 2.0-4.0 | 2.8-3.2 | 2.5-3.5 | 2.0-4.0 |
| Glycerin | 0-0.7 | 0.3-0.5 | 0.4 | 0.1-0.6 |
| MMB | 0 | 2.5-3.5 | 2.5-5.0 | 2.5-3.5 |
| Cetyl alcohol | 1.0-2.5 | 1.3-1.7 | 1.5-1.7 | 1.0-2.5 |
| STPP | 0 | 0 | 0.8-2.2 | 1.5-1.6 |
| Sodium Bisulfate | 0 | 0 | 0.4-0.6 | 0.4-0.6 |
| DPM | 8.0-15.0 | 0 | 10.0-12.0 | 8.0-15.0 |
| APG (DOW) | 2.8-3.0 | 3.0-3.2 | 0.5-3.5 | 2.3-2.7 |
| Potash | 1.5-3.0 | 1.8-2.2 | 1.7-2.5 | 2.0 |
| Alkyl | 2.5-3.0 | 3.0-3.5 | 1.5-6.0 | 2.5-3.5 |
| Polyglycosides | | | | |
| Polysorbate 20 | 0-0.1 | 0.1-0.3 | 0.01-0.6 | 0.01-0.6 |
| Potassium | 0.01-0.2 | 0.01-0.1 | 0.01-0.4 | 0-0.4 |
| Sorbate | | | | |
| Quaternary | 0.005-0.007 | 0 | 0.005-0.007 | 0-0.007 |
| ammonium | | | | |
| cations | | | | |
| Polysaccharide | 0-0.1 | 0.01-0.3 | 0.01-0.1 | 0-0.1 |
| (Xantan) | | | | |
| Sodium Biborate | 0 | 0 | 0.01-0.1 | 0-0.1 |
| Potassium 2- | 0 | 0-0.5 | 0.2-1.0 | 0-1.0 |
| ethylhexanoate | | | | |
| ABC | 0 | 0-0.5 | 0.3-3.5 | 0-3.5 |
| Sodium Benzoate | 0 | 0 | 0.01-0.4 | 0.01-0.4 |
| Mono Propylene | 3.0-5.0 | 2.0-5.0 | 1.7-12.0 | 2.0-5.0 |
| Glycol | | | | |
| Meta Silicate | 0.8-1.8 | 1.0-1.5 | 0.2-2.5 | 0.8-1.8 |
| Nitrate | 0.1-0.3 | 0-0.2 | 0-0.2 | 0.1-0.3 |
| P₂O₅ | 0-0.2 | 0.1-0.3 | 0.1-0.3 | 0-0.2 |
| K₂O | 0.1-0.3 | 0-0.2 | 0.1-0.3 | 0-0.2 |
| Metallic Chelates | 0.001-0.002 | 0-0.01 | 0.001-0.005 | 0.002-0.004 |
| Purified i. water | To 100% | To 100% | To 100% | To 100% |

Thus, it is envisaged that the above can be realistically replicated and used for many uses, including but not limited to food industry and foodstuffs treatments, oil and oily substance removal, treatment through fogging with foggers in storage and between locations, canal cleansing, antibacterial uses, antifungal uses, sanitary and medical uses.

It will be appreciated that the above descriptions are intended to only serve as examples, and that many other embodiments are possible within the spirit and scope of the present invention.

What is claimed is:

1. An eco-friendly composition for industrial and/or domestic applications comprising:
(a) about 1.0% to about 5.0% of Sodium Carbonate;
(b) about 0.1% to about 6.0% Potassium Hydroxide;
(c) about 10.0% to about 12.0% DPM;
(d) about 2.3% to about 2.7% APG; and
(d) about to 1.5% to about 6.0% Alkyl Polyglycosides.

2. The eco-friendly composition for industrial and/or domestic applications of claim 1, further comprising about 0.1% to about 0.3% K₂O.

3. The eco-friendly composition for industrial and/or domestic applications of claim 1, further comprising about 0.8% to about 2.2% STPP.

4. The eco-friendly composition for industrial and/or domestic applications of claim 1, further comprising about 0.4% to about 0.6% Sodium Bisulfate.

5. The eco-friendly composition for industrial and/or domestic applications of claim 1, further comprising about 0.1% to about 0.3% Nitrate.

6. The eco-friendly composition for industrial and/or domestic applications of claim 1, further comprising about 0.01% to about 0.4% Potassium Sorbate.

7. The eco-friendly composition for industrial and/or domestic applications of claim 6, further comprising about 0.01% to about 0.1% Polysaccharide (Xantan).

8. The eco-friendly composition for industrial and/or domestic applications of claim 6, further comprising about 1.7% to about 12.0% Mono Propylene Glycol.

9. The eco-friendly composition for industrial and/or domestic applications of claim 6, further comprising about 0.1% to about 0.3% P₂O₅.

10. The eco-friendly composition for industrial and/or domestic applications of claim 9, further comprising about 0.5% to about 0.7% HiTec151™.

11. The eco-friendly composition for industrial and/or domestic applications of claim 9, further comprising about 2.0% to about 4.0% vinegar.

12. The eco-friendly composition for industrial and/or domestic applications of claim 9, further comprising about 1.3% to about 3.0% Salidin 20.

13. The eco-friendly composition for industrial and/or domestic applications of claim 9, further comprising about 2.5% to about 3.5% MMB.

14. The eco-friendly composition for industrial and/or domestic applications of claim 9, further comprising about 0.01% to about 0.7% Glycerin.

15. The eco-friendly composition for industrial and/or domestic applications of claim 9, further comprising about 1.5% to about 3.0% Potash.
